(19) United States
(12) Patent Application Publication
(10) Pub. No.: US 2018/0162296 A1
(43) Pub. Date: Jun. 14, 2018

(54) WIRE HARNESS FIXING CLAMP

(71) Applicants: Sumitomo Wiring Systems, Ltd., Yokkaichi (JP); TOYOTA JIDOSHA KABUSHIKI KAISHA, Toyota-shi, (JP)

(72) Inventors: Hiroyuki OOTSUKI, Yokkaichi (JP); Takamasa KAWAMURA, Yokkaichi (JP); Toshinori MURAMOTO, Nagoya-shi (JP); Hiroshi KOBAYASHI, Okazaki-shi (JP); Motoya HARA, Nisshin-shi (JP)

(21) Appl. No.: 15/826,847

(22) Filed: Nov. 30, 2017

(30) Foreign Application Priority Data
Dec. 9, 2016 (JP) 2016-239303

(51) Int. Cl. B60R 16/02; H01B 7/00; H02G 3/32; F16L 3/233

(52) U.S. Cl. CPC B60R 16/0215; F16L 3/233; H02G 3/32; H01B 7/0045

(57) ABSTRACT

A wire harness fixing clamp includes: an electric wire fixing part being attachable to an electric wire bundle; and a clamp part including a column part and a pair of locking pieces extending while sloping outward from a distal end to a proximal end of the column part. The column part has a recess which is defined by a pair of side surfaces and a bottom surface facing the distal end of the column part and into which a protrusion of a distinguishing jig for distinguishing between different types of clamps is insertable.

### CROSS REFERENCE TO RELATED APPLICATIONS

This application claims the priority of Japanese patent application JP2016-239303 filed on Dec. 9, 2016, the entire contents of which are incorporated herein.

### BACKGROUND

### Field

The present invention relates to technology for distinguishing between different types of clamps attached to a wire harness.

### Description of the Background Art

Japanese Unexamined Patent Application Publication No. 2005-122975 discloses that, as a wiring clip to be attached to a wire harness, there are wiring clips of a variety of part numbers that differ in outside shape and size of a fixing part and in outside shape and size of a locking part. It also discloses that, when the wiring clips of a variety of part numbers are positioned on a wiring board, supporting members having housing holes shaped to correspond to the fixing part and the locking part are used.

In some cases, however, there are wiring clips being substantially similar in outside shape and size of the fixing part and the locking part, but having different part numbers. In such cases, it is sometimes difficult to distinguish between the wiring clips of different part numbers by changing the shapes of the housing holes as disclosed in Japanese Unexamined Patent Application Publication No. 2005-122975.

### SUMMARY

An object is to distinguish between different types of wire harness fixing clamps so that the wire harness fixing clamps can be set to jigs, even if the wire harness fixing clamps are similar in outside shape and size.

A wire harness fixing clamp according to the first aspect includes: an electric wire fixing part being attachable to an electric wire bundle; and a clamp part including a column part and a pair of locking pieces extending while sloping outward from a distal end to a proximal end of the column part. The column part has a recess which is defined by a pair of side surfaces and a bottom surface facing the distal end of the column part and into which a protrusion of a distinguishing jig for distinguishing between different types of clamps is insertable.

With this configuration, the clamp part cannot fully be fit and set into the distinguishing jig if the width of the recess is smaller than the width of the protrusion of the distinguishing jig. The clamp part also cannot fully be fit and set into the distinguishing jig if the bottom surface of the recess is located to come into contact with the protrusion in the process of setting the clamp part into the distinguishing jig. Thus, even if different types of wire harness fixing clamps are similar in outside shape and size, the wire harness fixing clamps can be distinguished from each other, and set to distinguishing jigs when the recesses of the wire harness fixing clamps differ in width and in location of the bottom surface.

The second aspect is the wire harness fixing clamp according to the first aspect, wherein the recess of the column part includes a plurality of recesses having different shapes.

With this configuration, various types of wire harness fixing clamps can distinguished from one another by a combination of the recesses.

The third aspect is the wire harness fixing clamp according to the second aspect, wherein the plurality of recesses differ in width between the pair of side surfaces and in location of the bottom surface.

The fourth aspect is the wire harness fixing clamp according to the second or the third aspect, wherein the plurality of recesses include two recesses, the electric wire fixing part protrudes at one side of the clamp part, and one of the two recesses is located at a side at which the electric wire fixing part protrudes, and the other one of the two recesses is located at a side opposite the side at which the one of the two recesses is located.

These and other objects, features, aspects and advantages of the present design will become more apparent from the following detailed description when taken in conjunction with the accompanying drawings.

### BRIEF DESCRIPTION OF THE DRAWINGS

FIG. 1 is a schematic view illustrating a wire harness WH;

FIG. 2 is a partial schematic elevation view illustrating a first wire harness fixing clamp;

FIG. 3 is a schematic bottom view illustrating the first wire harness fixing clamp;

FIG. 4 is a partial schematic elevation view illustrating a second wire harness fixing clamp;

FIG. 5 is a schematic bottom view illustrating the second wire harness fixing clamp;

FIG. 6 is an illustrative view illustrating the state of the first wire harness fixing clamp having been set to a first set jig;

FIG. 7 is an illustrative view illustrating the state of the second wire harness fixing clamp to be set to the first set jig;

FIG. 8 is an illustrative view illustrating the state of the second wire harness fixing clamp having been set to a second set jig;

FIG. 9 is an illustrative view illustrating the state of the first wire harness fixing clamp to be set to the second set jig; and

FIG. 10 is a schematic bottom view illustrating a wire harness fixing clamp according to a modification.

### DESCRIPTION OF THE PREFERRED EMBODIMENTS

Wire harness fixing clamps according to an embodiment will be described below.

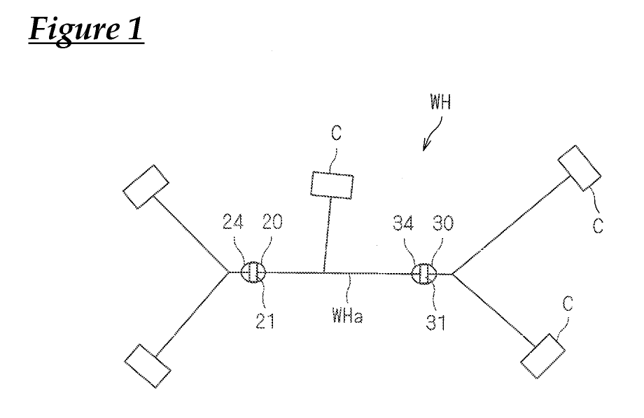

FIG. 1 is a schematic view illustrating a wire harness WH. The wire harness WH has configuration in which a plurality of electric wires are bound together while diverging along wiring paths in a vehicle and the like as a target of fitting. The configuration in which the plurality of electric wires are bound together while diverging along the wiring paths is referred to as a wire harness body WHa. Binding of the wire harness WH is achieved by winding of adhesive tape, a cable tie, and the like. At each end of the wire harness WH, a terminal at the end of an electric wire is connected to a connector C. With the wire harness WH being fit in the vehicle and the like, each connector C is connectorized to various electric parts mounted on the vehicle and the like. This allows the wire harness WH to serve as a wiring member electrically connecting various electric parts together in the vehicle and the like.

To the above-mentioned wire harness WH, wire harness fixing clamps are attached as parts that can be fixed to the vehicle and the like. A first wire harness fixing clamp 20 and a second wire harness fixing clamp 30 are herein attached to the wire harness WH.

Another cramp or a protective part, such as a corrugated tube, is sometimes attached to the wire harness WH as necessary.

The first wire harness fixing clamp 20 and the second wire harness fixing clamp 30, which are different types of wire harness fixing clamps, are attached to the above-mentioned wire harness WH.

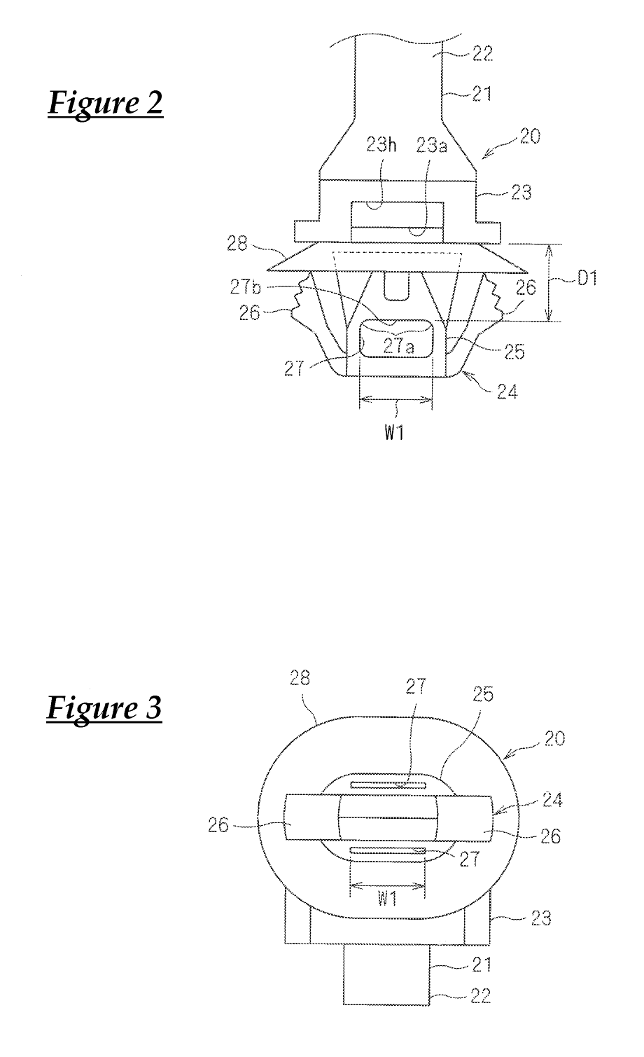

FIG. 2 is a partial schematic elevation view illustrating the first wire harness fixing clamp 20, and FIG. 3 is a schematic bottom view illustrating the first wire harness fixing clamp 20.

The first wire harness fixing clamp 20 includes an electric wire fixing part 21 and a clamp part 24.

The electric wire fixing part 21 is a part fixed to a bundle of a plurality of electric wires. The electric wire fixing part 21 herein includes a band part 22 and a band fixing part 23.

The band part 22 is in the form of an elongated strip, and can be wound around the bundle of electric wires. One main surface (a surface facing inward when the band part 22 is wound around the bundle) of the band part 22 has a plurality of engagement recesses formed to be arranged along a direction in which the band part 22 extends. The engagement recesses can selectively engage with a band engagement protrusion, which will be described below.

The band fixing part 23 is connected to one end of the band part 22, and can fix the band part 22 with the band part 22 being wound around the bundle of electric wires.

Specifically, the band fixing part 23 is flat. The band fixing part 23 has an insertion hole 23h penetrating the band fixing part 23. The insertion hole 23h is shaped so that the band part 22 is insertable into the insertion hole 23h, and has therein an engagement protrusion 23a that can selectively engage with the plurality of engagement recesses of the band part 22.

With the band part 22 being wound around the bundle of electric wires, the band part 22 is inserted into the insertion hole 23h from a distal end thereof. When the distal end of the band part 22 is pulled, the engagement protrusion 23a engages with one of the engagement recesses of the band part 22 with the band part 22 fastening the bundle of electric wires. The electric wire fixing part 21 is thus fixed to the bundle of electric wires.

The electric wire fixing part may not necessarily have the above-mentioned configuration. For example, the electric wire fixing part may be in the form of an elongated plate, and may be wound and fixed around the bundle of electric wires with adhesive tape or the like. The electric wire fixing part also may be in the form of a protector covering the bundle of electric wires, and may be fixed while covering the bundle of electric wires.

The clamp part 24 is a part fixed to a fixing target part, such as the body of the vehicle and the like. The clamp part 24 herein includes a column part 25 and a pair of locking pieces 26.

The clamp part 24 protrudes outward from one main surface of the electric wire fixing part 21. The pair of locking pieces 26 extends while sloping outward from a distal end to a proximal end of the column part 25. Proximal end portions of the pair of locking pieces 26 are narrower (thinner) than the other portions, and the pair of locking pieces 26 can be elastically deformed inward mainly by elastically deforming the proximal end portions. Outward portions at the distal ends of the pair of locking pieces 26 each have a plurality of steps, and one of the plurality of steps selectively engages with a peripheral portion of a fixing hole of the fixing target part with the clamp part 24 being inserted in the fixing hole.

A Belleville spring 28 spreading toward a distal end of the clamp part 24 is formed at a proximal end of the clamp part 24 (the proximal end of the column part 25).

The clamp part 24 is fixed to the fixing target part as described below. That is to say, the fixing target part has the fixing hole, and the clamp part 24 is inserted into the fixing hole. Outward surfaces of the pair of locking pieces 26 then come into contact with the peripheral portion of the fixing hole to elastically deform the pair of locking pieces 26 inward. Once portions of the pair of locking pieces 26 protruding outward the most go through the peripheral portion of the fixing hole, the pair of locking pieces 26 elastically returns to an original shape, and any of the plurality of steps at the distal end of each of the pair of locking pieces 26 engages with the peripheral portion of the fixing hole to be retained. The Belleville spring 28 is in contact with the fixing target part at the opposite side. The peripheral portion of the fixing hole of the fixing target part is thus interposed between the Belleville spring 28 and the distal ends of the pair of locking pieces 26, so that the clamp part 24 is fixed to the fixing target part.

The above-mentioned column part 25 has trenches 27. The trenches 27 have herein been formed at opposite sides of the column part 25 between the pair of locking pieces 26. The trench 27 may have been formed only at one side of the column part 25 between the pair of locking pieces 26.

The trenches 27 are each defined by a pair of side surfaces 27a extending along a direction in which the column part 25 extends, and a bottom surface 27b connected to the pair of side surfaces 27a at a side closer to the proximal end of the column part 25 and facing the distal end of the column part 25. The distance between the pair of side surfaces 27a and the location of the bottom surface 27b will be described in more details in relation to trenches 37 of the second wire harness fixing clamp 30.

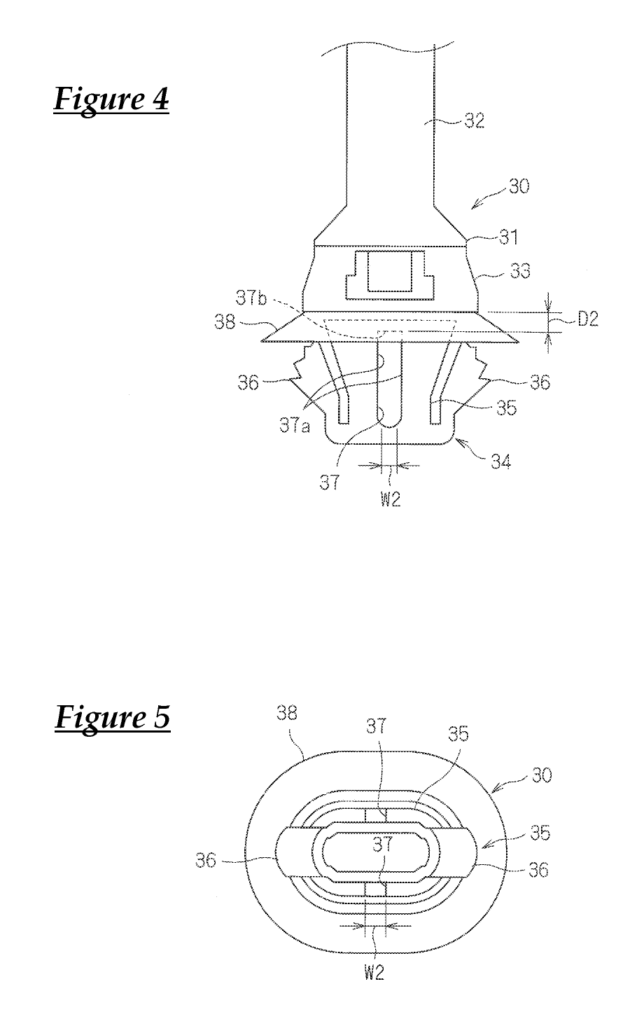

FIG. 4 is a partial schematic elevation view illustrating the second wire harness fixing clamp 30, and FIG. 5 is a schematic bottom view illustrating the second wire harness fixing clamp 30.

The second wire harness fixing clamp 30 includes an electric wire fixing part 31 and a clamp part 34.

The electric wire fixing part 31 is a part fixed to the bundle of electric wires as with the above-mentioned electric wire fixing part 21.

As with the above-mentioned clamp part 24, the clamp part 34 includes a column part 35, which corresponds to the column part 25, and a pair of locking pieces 36, which corresponds to the pair of locking pieces 26. As with the clamp part 24, the clamp part 34 includes a Belleville spring 38, which corresponds to the Belleville spring 28. The clamp part 34 is fixed to the fixing target part in a similar manner to the clamp part 24 fixed to the fixing target part.

The above-mentioned clamp parts 24 and 34 have the same outside shape or similar outside shapes. The similar outside shapes of the clamp parts 24 and 34 herein mean that the outside shapes of the clamp parts 24 and 34 are similar to each other to the extent that, even when set recesses (see set recesses described below) are formed to correspond to respective shapes of the clamp parts 24 and 34, any one of the clamp parts 24 and 34 can be fit into a set recess formed to correspond to the other one of the clamp parts 24 and 34. In particular, the distance between the pair of locking pieces 26 of the clamp part 24 and the distance between the pair of locking pieces 36 of the clamp part 34 are the same or similar to each other, the thickness of the column part 25 and the thickness of the column part 35 are the same or similar to each other, and the outside shape and the size of the Belleville spring 28 and the outside shape and the size of the Belleville spring 38 are the same or similar to each other.

The first wire harness fixing clamp 20 and the second wire harness fixing clamp 30, however, are not exactly the same in terms of the shape and the function except for the configuration of the trenches 27 and the trenches 37 described below. For example, in the first wire harness fixing clamp 20, the band fixing part 23 protrudes at one side of the Belleville spring 28 so that the bundle of electric wires is supported at a location laterally offset from the clamp part 24, whereas, in the second wire harness fixing clamp 30, the band fixing part 33 does not protrude from the Belleville spring 38 so that the bundle of electric wires is supported directly above the clamp part 34. It is thus required to avoid fixing of the wrong first wire harness fixing clamp 20 or second wire harness fixing clamp 30 to the wire harness body WHa.

The trenches 27 of the first wire harness fixing clamp 20 and the trenches 37 of the second wire harness fixing clamp 30 thus have different shapes.

That is to say, the width W1 between the pair of side surfaces 27a of each of the trenches 27 of the clamp part 24 of the first wire harness fixing clamp 20 is greater than the width W2 between the pair of side surfaces 37a of each of the trenches 37 of the clamp part 34 of the second wire harness fixing clamp 30. The distance D1 between the proximal end of the clamp part 24 and the bottom surface 27b facing the distal end of the clamp part 24 of each of the trenches 27 of the clamp part 24 of the first wire harness fixing clamp 20 is greater than the distance D2 between the proximal end of the clamp part 34 and the bottom surface 37b facing the distal end of the clamp part 34 of each of the trenches 37 of the clamp part 34 of the second wire harness fixing clamp 30. In other words, the length of each of the trenches 27 is smaller than the length of each of the trenches 37.

By changing the widths and the lengths (the locations of the bottom surfaces 27b and 37b) of the trenches 27 and the trenches 37, fixing of the first wire harness fixing clamp 20 and the second wire harness fixing clamp 30 to wrong locations of the wire harness body WHa can be avoided.

That is to say, the trenches 27 are examples of recesses into which protrusions (regulation protrusions 54 described below) of a set jig as a distinguishing jig for distinguishing between different types of clamps are insertable, and the trenches 37 are examples of recesses into which protrusions (regulation protrusions 64 described below) of a set jig as a distinguishing jig for distinguishing between different types of clamps are insertable. The protrusions may penetrate in a direction in which the column parts 25 and 35 extend or laterally.

An example of distinguishing between the above-mentioned first wire harness fixing clamp 20 and second wire harness fixing clamp 30 to avoid fixing to wrong locations will be described.

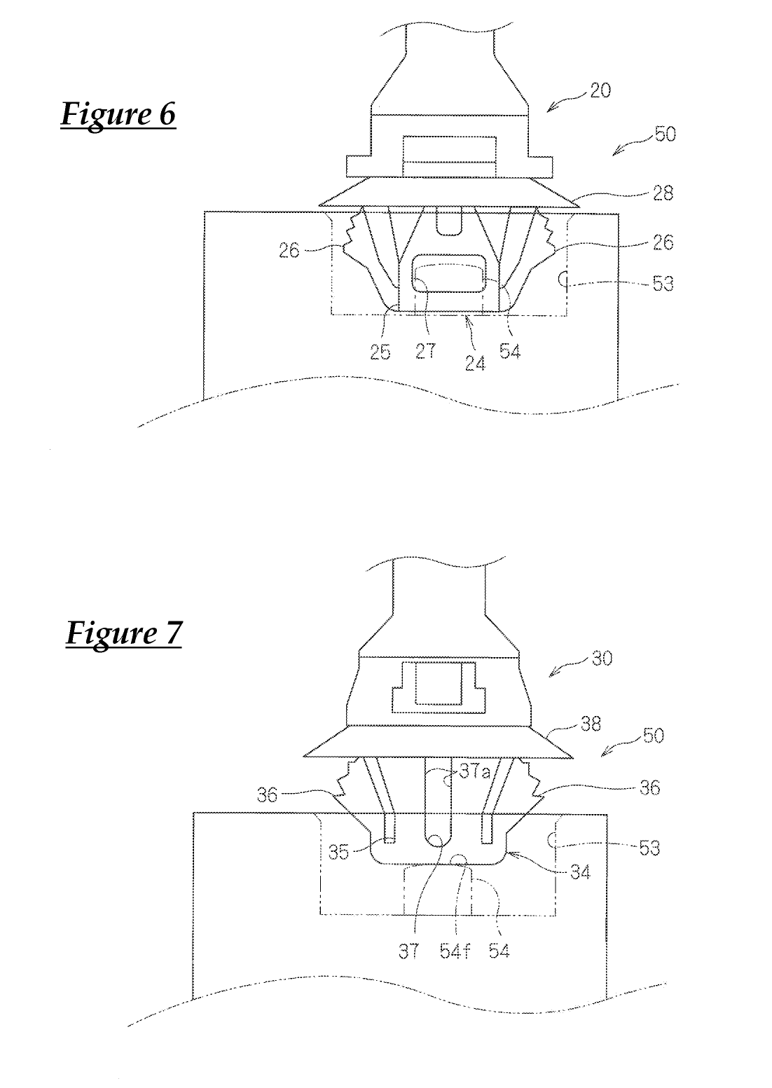

FIG. 6 is an illustrative view illustrating the state of the first wire harness fixing clamp 20 having been set to a first set jig 50, and FIG. 7 is an illustrative view illustrating the state of the second wire harness fixing clamp 30 to be set to the first set jig 50.

The first set jig 50 is an example of the distinguishing jig for distinguishing between different types of clamps, and is provided to stand on a drafting board for assembly of the wire harness and the like. The first set jig 50 herein has configuration in which a jig body 52 in the form of a rectangular parallelepiped block is supported on a drafting board body 42 by a rod-like member and the like.

The jig body 52 has a set recess 53 opening upward and having a bottom. The set recess 53 has been recessed so that the clamp part 24 can be housed therein.

The set recess 53 is set to have the shape and the size that are the same as or greater than the shape and the size of the clamp part 24 in plan view. The set recess 53 is set so that the clamp part 24 of the first wire harness fixing clamp 20 can completely be housed therein, but a clamp part larger than the clamp part 24 cannot completely be housed therein.

The regulation protrusions 54 that can be fit into the trenches 27 of the first wire harness fixing clamp 20 have been formed in the set recess 53. The width W11 of each of the regulation protrusions 54 is set to be the same as or smaller than the width W1 of each of the trenches 27 of the first wire harness fixing clamp 20 but to be greater than the width W2 of each of the trenches 37 of the second wire harness fixing clamp 30 and the width W12 of each of the regulation protrusions 64 described below. The distance D11 between a regulation surface 54f of each of the regulation protrusions 54 located closer to the opening of the set recess 53 and the opening of the set recess 53 is set to be greater than the distance D12 between a regulation surface 64f of each of the regulation protrusions 64 located closer to the opening of the set recess 63 and the opening of the set recess 63 described below.

As illustrated in FIG. 6, when the clamp part 24 of the first wire harness fixing clamp 20 is to be fit into the set recess 53, the column part 25 and the pair of locking pieces 26 of the clamp part 24 are fit into the set recess 53 while the regulation protrusions 54 are fit into the trenches 27, so that the clamp part 24 as a whole is fit into the set recess 53.

On the other hand, as illustrated in FIG. 7, when the clamp part 34 of the second wire harness fixing clamp 30 is to be fit into the set recess 53, the regulation protrusions 54 come into contact with the column part 35 at opposite sides of the trenches 37. The clamp part 34 cannot fully be fit into the set recess 53 in the process of fitting the clamp part 34 into the set recess 53.

This means that the first wire harness fixing clamp 20 can fully be fit and set to the first set jig 50, but the second wire harness fixing clamp 30 cannot fully be fit to the first set jig 50. This enables an operator to realize that he/she tries to set the wrong second wire harness fixing clamp 30, from the fact that the second wire harness fixing clamp 30 cannot fully be fit into the set recess 53.

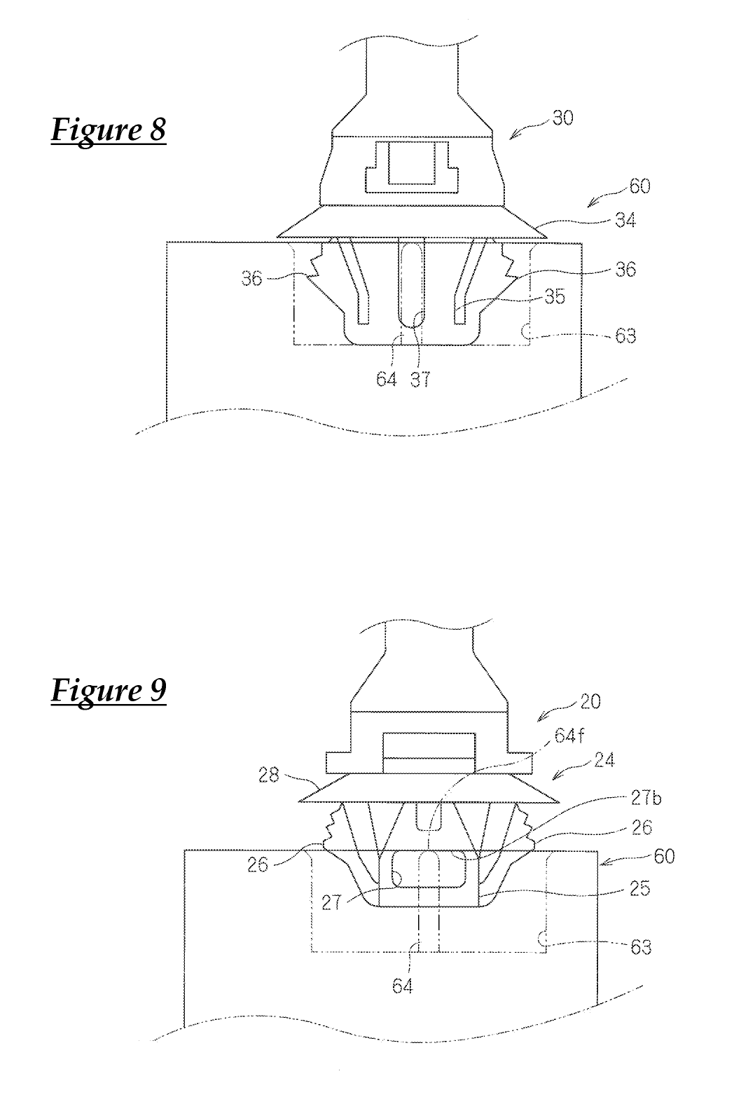

FIG. 8 is an illustrative view illustrating the state of the second wire harness fixing clamp 30 having been set to a second set jig 60, and FIG. 9 is an illustrative view illustrating the state of the first wire harness fixing clamp 20 to be set to the second set jig 60.

The second set jig 60 is an example of the distinguishing jig for distinguishing between different types of clamps, and is provided to stand on the drafting board for assembly of the wire harness and the like. The second set jig 60 herein has configuration in which a jig body 62 in the form of a rectangular parallelepiped block is supported on the drafting board body 42 by a rod-like member and the like.

The jig body 62 has a set recess 63 opening upward and having a bottom. The set recess 63 has been recessed so that the clamp part 34 can be housed therein.

The shape and the size of the clamp part 24 of the first wire harness fixing clamp 20 are the same as or similar to the shape and the size of the clamp part 34 of the second wire harness fixing clamp 30, so that the set recesses 53 and 63 have similar configuration.

The regulation protrusions 64 that can be fit into the trenches 37 of the second wire harness fixing clamp 30 have been formed in the set recess 63. The width W12 of each of the regulation protrusions 64 is set to be the same as or smaller than the width W2 of each of the trenches 37 of the second wire harness fixing clamp 30 and to be smaller than the width W1 of each of the trenches 27 of the first wire harness fixing clamp 20 and the width W11 of each of the regulation protrusions 54. The distance D12 between the regulation surface 64f of each of the regulation protrusions 64 located closer to the opening of the set recess 63 and the opening of the set recess 63 is set to be smaller than the distance D11 between the regulation surface 54f of each of the regulation protrusions 54 located closer to the opening of the set recess 53 and the opening of the set recess 53.

As illustrated in FIG. 8, when the clamp part 34 of the second wire harness fixing clamp 30 is to be fit into the set recess 63, the column part 35 and the pair of locking pieces 36 of the clamp part 34 are fit into the set recess 63 while the regulation protrusions 64 are fit into the trenches 37, so that the clamp part 34 as a whole is fit into the set recess 63.

On the other hand, as illustrated in FIG. 9, when the clamp part 24 of the first wire harness fixing clamp 20 is to be fit into the set recess 63, the regulation protrusions 64 come into contact with the bottom surfaces 27b of the trenches 27. The clamp part 24 cannot fully be fit into the set recess 63 in the process of fitting the clamp part 24 into the set recess 63.

This means that the second wire harness fixing clamp 30 can fully be fit and set to the second set jig 60, but the first wire harness fixing clamp 20 cannot fully be fit to the second set jig 60. This enables the operator to realize that he/she tries to set the wrong first wire harness fixing clamp 20, from the fact that the first wire harness fixing clamp 20 cannot fully be fit into the set recess 63.

According to the present embodiment, the clamp parts 24 and 34 cannot fully be fit and set into the set recesses 53 and 63 if the width of each of the trenches 27 and the trenches 37 is smaller than the width of each of the regulation protrusions 54 and the regulation protrusions 64 as described above. The clamp parts 24 and 34 also cannot fully be fit and set to the distinguishing jigs if the bottom surface of each of the trenches 27 and the trenches 37 is located to come into contact with each of the regulation protrusions 54 and the regulation protrusions 64 in the process of setting the clamp parts 24 and 34 into the set recesses 53 and 63. Thus, even if the wire harness fixing clamps 20 and 30, which are different types of wire harness fixing clamps, are similar in outside shape and size, the wire harness fixing clamps 20 and 30 can be distinguished from each other and set into the set recesses 53 and 63 of the distinguishing jigs when the trenches 27 and 37 of the wire harness fixing clamps 20 and 30 differ in width and in location of the bottom surface.

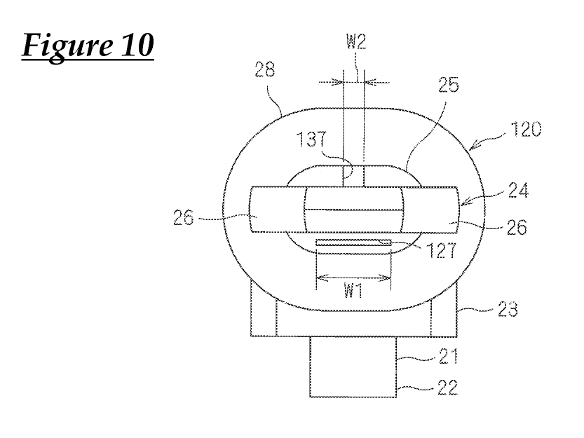

As illustrated in a wire harness fixing clamp 120 shown in FIG. 10, trenches 127 and 137 may be formed as a plurality of recesses, and the trenches 127 and 137 may have different shapes. The configuration of the wire harness fixing clamp 120 other than the configuration of the trenches 127 and 137 is similar to that of the above-mentioned first wire harness fixing clamp 20.

The trenches 127 and 137 preferably differ both in width and in location of the bottom surface. In the example shown in FIG. 10, the trench 127 has a similar shape to the above-mentioned trench 27, and the trench 137 has a similar shape to the above-mentioned trench 37. The trench 127 is located at a side at which the band part 22 extends, and the trench 137 is located at a side opposite the side at which the trench 127 is located. The trenches 127 and 137 are thus determined by using the side at which the band part 22 extends as a reference side. Thus, when the regulation protrusions (see the above-mentioned regulation protrusions 54 and 64) of the set jig are formed in the set recess of the set jig to correspond to the respective trenches 127 and 137 by using the side at which the band part 22 extends as the reference side, only the right wire harness fixing clamp 120 can be set to the set jig.

According to the present modification, the wire harness fixing clamp 120 that can be set to the set jig can be determined by a combination of the relationship between the trench 127 and the regulation protrusion corresponding to the trench 127 and the relationship between the trench 137 and the regulation protrusion corresponding to the trench 137, and thus more types of clamps can be distinguished.

Configurations described in the above-mentioned embodiment and modification can appropriately be combined unless any contradiction occurs.

While the invention has been described in detail above, the foregoing description is in all aspects illustrative and not restrictive. It is understood that numerous modifications not having been described can be devised without departing from the scope of the present invention.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A wire harness fixing clamp comprising:
an electric wire fixing part being attachable to an electric wire bundle; and
a clamp part including a column part and a pair of locking pieces extending while sloping outward from a distal end to a proximal end of said column part, said column part having a recess which is defined by a pair of side surfaces and a bottom surface facing said distal end of said column part and into which a protrusion of a distinguishing jig for distinguishing between different types of clamps is insertable.

2. The wire harness fixing clamp according to claim 1, wherein
said recess of said column part comprises a plurality of recesses having different shapes.

3. The wire harness fixing clamp according to claim 2, wherein
said plurality of recesses differ in width between said pair of side surfaces and in location of said bottom surface.

4. The wire harness fixing clamp according to claim 2, wherein
said plurality of recesses comprise two recesses,
said electric wire fixing part protrudes at one side of said clamp part, and
one of said two recesses is located at a side at which said electric wire fixing part protrudes, and the other one of said two recesses is located at a side opposite said side at which said one of said two recesses is located.
